(19) United States
(12) Patent Application Publication
(10) Pub. No.: US 2019/0085171 A1
(43) Pub. Date: Mar. 21, 2019

(54) DURABLE HYDROPHOBIC COATING COMPOSITION

(71) Applicant: Agency for Science, Technology and Research, Singapore (SG)

(72) Inventors: Hong YAN, Singapore (SG); Jianwei XU, Singapore (SG)

(21) Appl. No.: 16/079,991

(22) PCT Filed: Feb. 24, 2017
(86) PCT No.: PCT/SG2017/050085

§ 371 Date: Aug. 24, 2018

(30) Foreign Application Priority Data
Feb. 24, 2016 (SG) 10201601394U

(51) Int. Cl. C09D 5/00; C09D 183/10; C08G 77/44

(52) U.S. Cl. CPC C09D 5/00; C08G 77/70; C08G 77/44; C09D 183/10

(57) ABSTRACT

This invention relates to a hydrophobic coating material comprising a silane-modified polyorganosiloxane. The invention also relates to a method of making such a coating material, the use of such a coating material, a method for coating a substrate with such a coating material, and a coated substrate obtainable by such a method. In a preferred embodiment, the silane-modified polyorganosiloxane prepared by reacting hydride-containing polyorganosiloxane with vinylsilane; or reacting vinyl-containing polyorganosilane with trimethoxysilane, triethoxysilane or trichlorosilane through hydrosilylation reaction is provided.

### TECHNICAL FIELD

The present invention relates to a coating material for hydrophobic coatings. The present invention also relates to a method of fabricating such a coating, and a method for coating an object with such a coating.

### BACKGROUND ART

Glass, plastics and ceramic materials have desirable bulk properties such as low cost, good strength, ease of processing, good aesthetics and practicality that has enabled them to become integral components of countless consumer goods and devices. However, keeping such materials clean and in some cases, transparent, can be difficult. Moreover, when dirt and other debris build up on surfaces, it can be a hazard, particularly if visibility through such materials is important.

One surface property of solid materials that may influence the cleanliness of the surface may be wettability. Wettability is normally characterized by measurement of a water contact angle (WCA) of a surface. The surface of most objects such as glass, plastic, ceramic, cardboard, cement board and metal are hydrophilic, with a water contact angle of less than or about 50 degrees. Surfaces with a water contact angle of greater than 90° are hydrophobic, and above 150° are considered to be superhydrophobic. Sometimes, it is highly desirable for conventional surfaces to have a hydrophobic property when such surfaces are employed in certain end-use applications, such as auto-motive window glass, shower stall doors, ceramic tiles in humid environments.

In general, hydrophobicity can be obtained by coating a substrate with a thin layer of a material which has both the chemical composition and the geometrical microstructure that confers hydrophobicity to a surface, so that the substrate can be exploited for various potential applications. In the past, many techniques such as electrochemical deposition, graft polymerization, sol-gel processing and chemical etching, have been proposed to generate artificial hydrophobic surfaces. However, most of these techniques are subject to several limitations. For example, if the hydrophobic coating material adheres to the surface of the substrate very weakly, it may become removed from the substrate easily, making the surface lose its hydrophobicity in practical applications. In addition, most conventional coatings may be made of expensive, environmentally toxic inorganic/organic materials, which cannot be easily applied to existing commercial products and equipment. Further, some conventional hydrophobic coatings require multiple layers or application steps during application, which often leads to more material being required and a more complicated application process. Therefore, the need for special equipment, high cost of special starting materials, harsh chemical treatment and the tedious multi-step production process of conventional hydrophobic coatings have caused them to have limited practical application.

In previous studies, perfluoro-components in combination with inorganic materials have also been used in an attempt to improve water repellency of hydrophobic coatings on glass and ceramic. However, many fluorochemicals have a tendency to leach out over time, especially when the surfaces have been subjected to recurrent cleaning or rubbing.

Polyorganosiloxanes is a versatile and widely used material for industrial applications, such as in surface finishes and maintenance, building, paints, and surface coatings. This is due to its predominant properties such as excellent processability, thermal stability, water repellency, extensive resistance to oxygen, ozone and UV-light, environmental benignity, and durability exemplified by lack of deformation or degradation over at least 10 years. However, the use of polyorganosiloxanes always suffers from drawbacks, such as low toughness and weak adhesiveness to surfaces. To overcome these drawbacks, blending with filler materials, such as silica nanoparticles, graphene oxide, carbon nanocubes and metal oxide particles are often used for the fabrication of hydrophobic or super-hydrophobic surfaces and coatings. However, such nanofillers affect the transparency of the coating layer, which prevents large-scale application of such coatings.

There is therefore a need to provide a coating material that overcomes or at least ameliorates, one or more of the disadvantages described above. Specifically, there is a need to develop an alternative coating composition which is safe to apply, environmentally friendly, and would provide effective and long-lasting hydrophobicity without the drawbacks mentioned above.

### SUMMARY

In an aspect, there is provided a coating material comprising a polymer having the following formula (I):

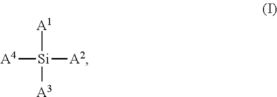

wherein A¹, A² and A³ are independently R¹ or L¹, and at least one of A¹, A², or A³ is L¹,

A⁴ is selected from the group consisting of hydrogen, optionally substituted alkenyl, R¹, L¹, M¹, and Z,

L¹ is

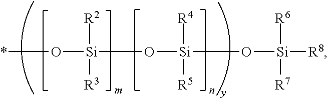

M¹ is

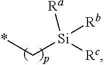

Z is

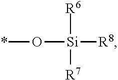

any two of R¹, R², R³, R⁴, R⁵, R⁶, R⁷ and R⁸ may independently optionally be joined together to form a ring,

m is 0 or an integer from 1 to 1000,

n is 0 or an integer from 1 to 100,

y is an integer from 1 to 1000,

R¹, R², R³, and R⁷ are independently optionally substituted alkyl or optionally substituted aryl,

R⁵ and R⁸ are independently selected from the group consisting of hydrogen, R¹, optionally substituted alkenyl, and M¹,

at least one of A⁴, R⁵ or R⁸ is M¹, wherein when R⁵ is M¹, n is not 0,

R^{a}, R^{b} and R^{c} are independently halogen or —OR⁹, wherein R⁹ is hydrogen or an alkyl, and

p is an integer from 1 to 10.

Advantageously, the coating material may be hydrophobic, having a water contact angle in the range of 100° to 145°. Further advantageously, the coating material may be corrosion resistant, chemically stable and thermally stable. The hydrophobic property of the coating material may remain unchanged upon treatment with strong mineral acid, strong corrosive alkali and heating at high temperatures (300° C.) for 3 days. More advantageously, the coating material may be durable, and resist scratching for up to 500 cycles. Further advantageously, the coating material may be strongly adhesive to a substrate that it is coated onto.

Further advantageously, the coating material may be optically transparent. Further advantageously, a thin layer of less than 700 nm of the coating material on a substrate may be sufficient to confer the hydrophobic properties.

More advantageously, the coating material may be fluoro-free and non-toxic. This may circumvent the issue of flurochemicals leaching out of the coating material and therefore may overcome the issue of the conventional coating materials losing hydrophobicity over time.

In another aspect, there is provided a method for preparing a coating material, the method comprising the steps of:

providing a polymer having the following formula (II):

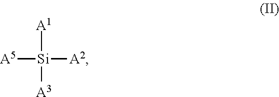

wherein A¹, A², and A³ are independently R¹ or L², and at least one of A¹, A², and A³ is L²,

A⁵ is selected from the group consisting of hydrogen, R¹, L² and Z, L² is

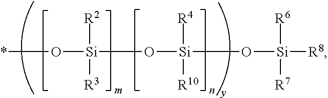

Z is

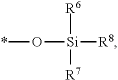

any two of R¹, R², R³, R⁴, R⁶, R⁷, R⁸ and R¹⁰ may independently optionally be joined together to form a ring,

m is 0 or an integer from 1 to 1000,

n is 0 or an integer from 1 to 100,

y is an integer from 1 to 1000,

R¹, R², R³, R⁴, R⁶, and R⁷ are independently optionally substituted alkyl or optionally substituted aryl,

R⁸ and R¹⁰ are independently selected from the group consisting of hydrogen or R¹ and

at least one of A⁵, R⁸ or R¹⁰ is hydrogen, wherein when R¹⁰ is hydrogen, n is not 0, and
contacting the polymer of formula (II) with M² in the presence of a catalyst to form a covalent bond,

wherein M² is

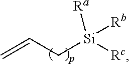

R^{a}, R^{b} and R^{c} are independently halogen or —OR⁹, wherein R⁹ is hydrogen or an alkyl, and

p is an integer from 1 to 10.

In another aspect, there is provided a method for preparing a coating material, the method comprising the steps of:

providing a polymer having the following formula (III):

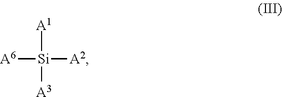

wherein A¹, A², and A³ are independently R¹ or L², and at least one of A¹, A², and A³ is L²,

A⁶ is selected from the group consisting of optionally substituted alkenyl, R¹, L³ and Z,

L³ is

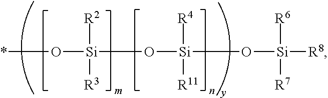

Z is

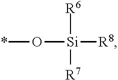

any two of R¹, R², R³, R⁴, R⁶, R⁷, R⁸ and R¹¹ may independently optionally be joined together to form a ring,

m is 0 or an integer from 1 to 1000,

n is 0 or an integer from 1 to 100,

y is an integer from 1 to 1000,

R¹, R², R³, R⁴, R⁶, and R⁷ are independently optionally substituted alkyl or optionally substituted aryl,

R⁸ and R¹¹ are independently selected from the group consisting of optionally substituted alkenyl or R¹¹ and

at least one of A⁶, R⁸ or R¹¹ is optionally substituted alkenyl, wherein when R¹¹ is optionally substituted alkenyl, n is not 0, and

contacting the polymer of formula (III) with M³ in the presence of a catalyst to form a covalent bond,

wherein M³ is

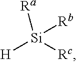

R^{a}, R^{b} and R^{c} are independently halogen or —OR⁹, wherein R⁹ is hydrogen or an alkyl.

Advantageously, the method of preparing the coating material provides an efficient and versatile way of producing the coating material from a variety of non-toxic and inexpensive starting materials. More advantageously, the method may circumvent the use of perfluorinated materials. Further advantageously, the method of preparing the coating material is a one-step reaction, facilitating simple and efficient synthesis of the coating material.

Further advantageously, the method may be performed at room temperature, in normal atmosphere and under atmospheric pressure, circumventing the need to heat the reaction mixture or to perform the reaction under pressure or under inert gas atmosphere. More advantageously, due to the simple method of preparing the coating material, the method may be easily scaled up for large scale synthesis.

In another aspect, there is provided the use of the coating material as defined above for coating a substrate.

Advantageously, the coating material may be used to coat a substrate. Further advantageously, the coating may be applied to a variety of hard or soft substrates, including glass, ceramic, metal, paper, wood and plastics such as polyethylene terephthalate (PET), polypropylene (PP), poly(methyl methacrylate) (PMMA). Advantageously, the substrate may be used in applications where surface hydrophobicity is required.

In another aspect, there is provided a method of coating a substrate, the method comprising the steps of:
a) dissolving a coating material as defined above in a solvent to form a coating solution;
b) applying the coating solution on the substrate; and
c) removing the solvent.

Advantageously, the method of coating may facilitate strong adhesion between the coating material and the substrate. More advantageously, the method of coating may not require additional coating processes. That is, the substrate to be coated may not have to undergo pre- or post-treatment processes. More advantageously, the application process may be simple, selected from processes such as roll coating, brush coating, spray coating or dip coating. Further advantageously, the coating solution may require a low concentration of the coating material (as low as 0.06 wt %), yet the resultant coating on the substrate may still achieve sufficient hydrophobicity. More advantageously, the curing of the coating material may be performed at room temperature, and may be fast (less than 20 minutes). More advantageously, the coating process may not require multiple layers to achieve the hydrophobicity.

In another aspect, there is provided a coated substrate obtainable by the method as defined above having hydrophobic properties.

Advantageously, the coated substrate may have hydrophobic properties by virtue of the coating material, even if the substrate itself is hydrophilic. Advantageously, the substrate may be used in applications where surface hydrophobicity is required.

### Definitions

The following words and terms used herein shall have the meaning indicated:

“Alkyl” as a group or part of a group refers to a straight or branched aliphatic hydrocarbon group, preferably a C₁-C₅₀ alkyl, preferably a C₁-C₁₂ alkyl, more preferably a C₁-C₁₀ alkyl, most preferably C₁-C₆ unless otherwise noted. Examples of suitable straight and branched C₁-C₆ alkyl substituents include methyl, ethyl, n-propyl, 2-propyl, n-butyl, sec-butyl, t-butyl, hexyl, and the like. The group may be a terminal group or a bridging group.

“Alkenyl” as a group or part of a group denotes an aliphatic hydrocarbon group containing at least one carbon-carbon double bond and which may be straight or branched preferably having 2-12 carbon atoms, more preferably 2-10 carbon atoms, most preferably 2-6 carbon atoms, in the normal chain. The group may contain a plurality of double bonds in the normal chain and the orientation about each is independently E or Z. Exemplary alkenyl groups include, but are not limited to, ethenyl, propenyl, butenyl, pentenyl, hexenyl, heptenyl, octenyl and nonenyl. The group may be a terminal group or a bridging group.

“Alkynyl” as a group or part of a group means an aliphatic hydrocarbon group containing a carbon-carbon triple bond and which may be straight or branched preferably having from 2-12 carbon atoms, more preferably 2-10 carbon atoms, more preferably 2-6 carbon atoms in the normal chain. Exemplary structures include, but are not limited to, ethynyl and propynyl. The group may be a terminal group or a bridging group.

“Halogen” represents chlorine, fluorine, bromine or iodine.

“Haloalkyl” refers to an alkyl group as defined herein in which one or more of the hydrogen atoms has been replaced with a halogen atom selected from the group consisting of fluorine, chlorine, bromine and iodine. A haloalkyl group typically has the formula CₙH₍₂ₙ₊₁₋ₘ₎Xₘ wherein each X is independently selected from the group consisting of F, Cl, Br and I. In groups of this type n is typically from 1 to 10, more preferably from 1 to 6, most preferably 1 to 3. m is typically 1 to 6, more preferably 1 to 3. Examples of haloalkyl include fluoromethyl, difluoromethyl and trifluoromethyl.

“Haloalkenyl” refers to an alkenyl group as defined herein in which one or more of the hydrogen atoms has been replaced with a halogen atom independently selected from the group consisting of F, Cl, Br and I.

“Haloalkynyl” refers to an alkynyl group as defined herein in which one or more of the hydrogen atoms has been replaced with a halogen atom independently selected from the group consisting of F, Cl, Br and I.

“Alkynyloxy” refers to an alkynyl-O— group in which alkynyl is as defined herein. Preferred alkynyloxy groups are C₁-C₆ alkynyloxy groups. The group may be a terminal group or a bridging group. If the group is a terminal group it is bonded to the remainder of the molecule through the oxygen atom.

“Hydroxyalkyl” refers to an alkyl group as defined herein in which one or more of the hydrogen atoms has been replaced with an OH group. A hydroxyalkyl group typically has the formula CₙH₍₂ₙ₊₁₋ₓ₎(OH)ₓ. In groups of this type n is typically from 1 to 10, more preferably from 1 to 6, most preferably from 1 to 3. x is typically from 1 to 6, more preferably from 1 to 4.

“Alkyloxy” refers to an alkyl-O— group in which alkyl is as defined herein. Preferably the alkyloxy is a C₁-C₆alkyloxy. Examples include, but are not limited to, methoxy and ethoxy. The group may be a terminal group or a bridging group.

“Alkyloxyalkyl” refers to an alkyloxy-alkyl- group in which the alkyloxy and alkyl moieties are as defined herein. The group may be a terminal group or a bridging group. If the group is a terminal group it is bonded to the remainder of the molecule through the alkyl group.

“Aryl” as a group or part of a group denotes (i) an optionally substituted monocyclic, or fused polycyclic, aromatic carbocycle (ring structure having ring atoms that are all carbon) preferably having from 5 to 12 atoms per ring. Examples of aryl groups include phenyl, naphthyl, and the like; (ii) an optionally substituted partially saturated bicyclic aromatic carbocyclic moiety in which a phenyl and a C₅₋₇ cycloalkyl or C₅₋₇ cycloalkenyl group are fused together to form a cyclic structure, such as tetrahydronaphthyl, indenyl or indanyl. The group may be a terminal group or a bridging group. Typically an aryl group is a C₆-C₁₈ aryl group.

“Arylalkyl” means an aryl-alkyl- group in which the aryl and alkyl moieties are as defined herein. Preferred arylalkyl groups contain a C₁₋₅ alkyl moiety. Exemplary arylalkyl groups include benzyl, phenethyl, 1-naphthalenemethyl and 2-naphthalenemethyl. The group may be a terminal group or a bridging group. If the group is a terminal group it is bonded to the remainder of the molecule through the alkyl group.

“Heteroaryl” either alone or part of a group refers to groups containing an aromatic ring (preferably a 5 or 6 membered aromatic ring) having one or more heteroatoms as ring atoms in the aromatic ring with the remainder of the ring atoms being carbon atoms. Suitable heteroatoms include nitrogen, oxygen and sulphur. Examples of heteroaryl include thiophene, benzothiophene, benzofuran, benzimidazole, benzoxazole, benzothiazole, benzisothiazole, naphtho[2,3-b]thiophene, furan, isoindolizine, xantholene, phenoxatine, pyrrole, imidazole, pyrazole, pyridine, pyrazine, pyrimidine, pyridazine, tetrazole, indole, isoindole, 1H-indazole, purine, quinoline, isoquinoline, phthalazine, naphthyridine, quinoxaline, cinnoline, carbazole, phenanthridine, acridine, phenazine, thiazole, isothiazole, phenothiazine, oxazole, isooxazole, furazane, phenoxazine, 2-, 3- or 4-pyridyl, 2-, 3-, 4-, 5-, or 8-quinolyl, 1-, 3-, 4-, or 5-isoquinolinyl 1-, 2-, or 3-indolyl, and 2-, or 3-thienyl. A heteroaryl group is typically a C₁-C₁₈ heteroaryl group. A heteroaryl group may comprise 3 to 8 ring atoms. A heteroaryl group may comprise 1 to 3 heteroatoms independently selected from the group consisting of N, O and S. The group may be a terminal group or a bridging group.

The term “optionally substituted” as used herein means the group to which this term refers may be unsubstituted, or may be substituted with one or more groups independently selected from alkyl, alkenyl, alkynyl, halogen, haloalkyl, haloalkenyl, haloalkynyl, alkynyloxy, hydroxyl, hydroxyalkyl, alkyloxy, alkyloxyalkyl, aryl, heteroaryl, arylalkyl.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF OPTIONAL EMBODIMENTS

The adhesive strength between the substrate and the coating material may be one of the determining factors of the quality of a hydrophobic coating. Therefore, it is highly desirable for a hydrophobic coating to achieve strong adhesion with the substrate.

In this disclosure, a novel silane terminated polyorganosiloxanes (SP) may be synthesized through hydrosilylation reaction or cross-linking reactions to covalently link a silane group with various polyorganosiloxanes.

There is provided a coating material comprising a polymer having the following formula (I):

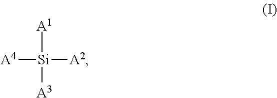

wherein A¹, A² and A³ may be independently R¹ or L¹, and at least one of A¹, A², or A³ may be L¹,

A⁴ may be selected from the group consisting of hydrogen, optionally substituted alkenyl, R¹, L¹, M¹, and Z,

L¹ is

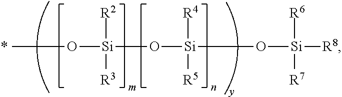

M¹ may be

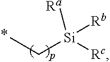

Z may be

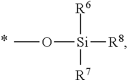

any two of R¹, R², R³, R⁴, R⁵, R⁶, R⁷ and R⁸ may independently optionally be joined together to form a ring,

m may be 0 or an integer from 1 to 1000,

n may be 0 or an integer from 1 to 100,

y may be an integer from 1 to 1000,

R¹, R², R³, R⁴, R⁶, and R⁷ may be independently optionally substituted alkyl or optionally substituted aryl,

R⁵ and R⁸ may be independently selected from the group consisting of hydrogen, R¹, optionally substituted alkenyl, and M¹,

at least one of A⁴, R⁵ or R⁸ may be M¹, wherein when R⁵ is M¹, n is not 0,

R^{a}, R^{b} and R^{c} may be independently halogen or —OR⁹, wherein R⁹ may be hydrogen or an alkyl, and

p may be an integer from 1 to 10.

Any two of R¹, R², R³, R⁴, R⁵, R⁶, R⁷ and R⁸ may independently optionally be joined together to form a ring. R¹ and R², R¹ and R³, R¹ and R⁴, R¹ and R⁵, R¹ and R⁶, R¹ and R⁷, R¹ and R⁸, R² and R³, R² and R⁴, R² and R⁵, R² and R⁶, R² and R⁷, R² and R⁸, R³ and R⁴, R³ and R⁵, R³ and R⁶, R³ and R⁷, R³ and R⁸, R⁴ and R⁵, R⁴ and R⁶, R⁴ and R⁷, R⁴ and R⁸, R⁵ and R⁶, R⁵ and R⁷, R⁵ and R⁸, R⁶ and R⁷, R⁶ and R⁸, or R⁷ and R⁸ may be joined together to form a ring. More than one ring may be formed. When A¹, A², A³ and A⁴ are L¹, any two of R¹, R², R³, R⁴, R⁵, R⁶, R⁷ and R⁸ may be joined together to form a cyclotetrasiloxane or a silsesquioxane.

m is 0 or an integer from 1 to 1000. m may be an integer from 1 to 10, 1 to 20, 1 to 50, 10 to 100, 1 to 200, 1 to 500, 10 to 20, 10 to 50, 10 to 100, 10 to 200, 10 to 500, 10 to 1000, 20 to 50, 20 to 100, 20 to 200, 20 to 500, 20 to 1000, 50 to 100, 50 to 200, 50 to 500, 50 to 1000, 100 to 200, 100 to 500, 100 to 5000, 200 to 500, 200 to 1000 or 500 to 1000.

n may be 0 or an integer from 1 to 100. n may be an integer from 1 to 5, 1 to 10, 1 to 20, 1 to 50, 5 to 10, 5 to 20, 5 to 50, 5 to 100, 10 to 20, 10 to 50, 10 to 100, 20 to 50, 20 to 100 or 50 to 100.

y is an integer from 1 to 1000. y may be an integer from 1 to 10, 1 to 20, 1 to 50, 10 to 100, 1 to 200, 1 to 500, 10 to 20, 10 to 50, 10 to 100, 10 to 200, 10 to 500, 10 to 1000, 20 to 50, 20 to 100, 20 to 200, 20 to 500, 20 to 1000, 50 to 100, 50 to 200, 50 to 500, 50 to 1000, 100 to 200, 100 to 500, 100 to 5000, 200 to 500, 200 to 1000 or 500 to 1000.

The optionally substituted alkyl may be optionally substituted C₁ to C₅₀ alkyl. Optionally substituted alkyl may be optionally substituted methyl, ethyl, n-propyl, isopropyl, n-butyl, sec-butyl, isobutyl, tert-butyl, n-pentyl, tert-pentyl, neo-pentyl, isopentyl, sec-pentyl, 3-pentyl, hexyl, heptyl or octyl. The optionally substituted aryl may be phenyl.

R¹, R², R³, R⁴, R⁶, and R⁷ may be independently methyl or phenyl.

R⁵ and R⁸ may be independently selected from the group consisting of hydrogen, R¹, optionally substituted alkenyl, and M¹.

The optionally substituted alkenyl may be an optionally substituted C₂ to C₁₀ alkenyl. Optionally substituted alkenyl may be ethenyl, propenyl, 1-butenyl, 2-butenyl, 1-pentenyl, 2-pentenyl, 1-hexenyl, 2-hexenyl or 3-hexenyl. The optionally substituted alkenyl may be ethenyl.

In an embodiment, A¹ and A³ may be R¹, A² may be L¹, and A⁴ may be Z, R¹, R², R³, R⁴, R⁶, R⁷ and R⁸ may be independently optionally substituted alkyl or optionally substituted aryl, and R⁵ may be M¹.

In another embodiment, A¹ and A³ may be R¹, A² may be L¹, and A⁴ may be M¹, and R¹, R², R³, R⁴, R⁵, R⁶, R⁷ and R⁸ may be independently optionally substituted alkyl or optionally substituted aryl.

In another embodiment, A¹ and A³ may be R¹, A² may be L¹, A⁴ may be Z, R¹, R², R³, R⁴, R⁵, R⁶, and R⁷ may be independently optionally substituted alkyl or optionally substituted aryl and R⁵ may be M¹.

In another embodiment, A¹, A² and A³ may be independently L¹, A⁴ may be Z, R², R³, R⁴, R⁶, R⁷ and R⁸ may be independently optionally substituted alkyl or optionally substituted aryl, and R⁵ may be M¹.

In another embodiment, A¹, A² and A³ may be independently L¹, A⁴ may be M¹, and R², R³, R⁴, R⁵, R⁶, R⁷ and R⁸ may be independently optionally substituted alkyl.

In another embodiment, A¹, A² and A³ may be independently L¹, A⁴ may be Z, R², R³, R⁴, R⁵, R⁶ and R⁷ may be independently optionally substituted alkyl or optionally substituted aryl, and R⁸ may be M¹.

R^{a}, R^{b} and R^{c} are independently halogen or —OR⁹, wherein R⁹ is hydrogen or an alkyl.

R^{a}, R^{b} and R^{c} may be independently selected from the group consisting of chloride, —OH, —OCH₃ and —OCH₂CH₃.

M may be selected from the group consisting of trimethoxysilane, triethoxysilane and trichlorosilane.

M may be used as anchor groups for further functionalization of substrates. The adhesion on substrates may be increased by increasing the number of anchor groups on the polyorganosiloxane group.

When M is trimethoxysilane, triethoxysilane or trichlorosilane, it may be hydrolyzed to form —(CH₂)ₚ—Si(OH)₃.

The coating material may further comprise a solvent. The solvent may be an organic solvent.

The organic solvent may be alcohols, ethers, esters or C₁ to C₄₀ hydrocarbons. The organic solvent may be toluene, ethyl acetate, isopropyl alcohol, ethanol or acetone.

There is also provided a method for preparing a coating material, the method comprising the steps of:

providing a polymer having the following formula (II):

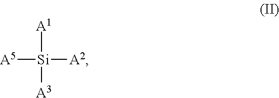

wherein A¹, A², and A³ may be independently R¹ or L², and at least one of A¹, A², and A³ may be L²,

A⁵ may be selected from the group consisting of hydrogen, R¹, L² and Z,

L² may be

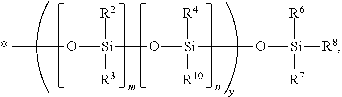

Z may be

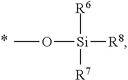

any two of R¹, R², R³, R⁴, R⁶, R⁷, R⁸ and R¹⁰ may independently optionally be joined together to form a ring,

m may be 0 or an integer from 1 to 1000,

n may be 0 or an integer from 1 to 100,

y may be an integer from 1 to 1000,

R¹, R², R³, R⁴, R⁶, and R⁷ may be independently optionally substituted alkyl or optionally substituted aryl,

R⁸ and R¹⁰ may be independently hydrogen or R¹ and

at least one of A¹, R⁸ or R¹⁰ may be hydrogen, wherein when R¹⁰ is hydrogen, n is not 0, and

contacting the polymer of formula (II) with M² in the presence of a catalyst to form a covalent bond,

wherein M² may be

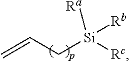

R^{a}, R^{b} and R^{c} may be independently halogen or —OR⁹, wherein R⁹ i may be hydrogen or an alkyl, and p may be an integer from 1 to 10.

In an embodiment, A¹ and A³ may be R¹, A² may be L², and A⁵ may be Z, R¹, R², R³, R⁴, R⁶, R⁷ and R⁸ may be independently optionally substituted alkyl or optionally substituted aryl, and R¹⁰ may be M².

In another embodiment, A¹ and A³ may be R¹, A² may be L², and A⁵ may be M², and R¹, R², R³, R⁴, R⁶, R⁷, R⁸ and R¹⁰ may be independently optionally substituted alkyl or optionally substituted aryl.

In another embodiment, A¹ and A³ may be R¹, A² may be L², A⁵ may be Z, R¹, R², R³, R⁴, R⁵, R⁶, and R⁷ may be independently optionally substituted alkyl or optionally substituted aryl and R¹⁰ may be M².

In another embodiment, A¹, A² and A³ may be independently L², A⁵ may be Z, R², R³, R⁴, R⁶, R⁷ and R⁸ may be independently optionally substituted alkyl or optionally substituted aryl, and R¹⁰ may be M².

In another embodiment, A¹, A² and A³ may be independently L², A⁵ may be M², and R², R³, R⁴, R⁶, R⁷, R⁸ and R¹⁰ may be independently optionally substituted alkyl.

In another embodiment, A¹, A² and A³ may be independently L², A⁵ may be Z, R², R³, R⁴, R⁶, R⁷ and R¹⁰ may be independently optionally substituted alkyl or optionally substituted aryl, and R⁸ may be M².

The polymer of formula (II) may have the formula (a) or (d) below where methylhydrosiloxane is on a terminal position of a linear or branched polyorganosiloxane or may have the formula (b) or (c) below where the methylhydrosiloxane is on the backbone of the polyorganosiloxane.

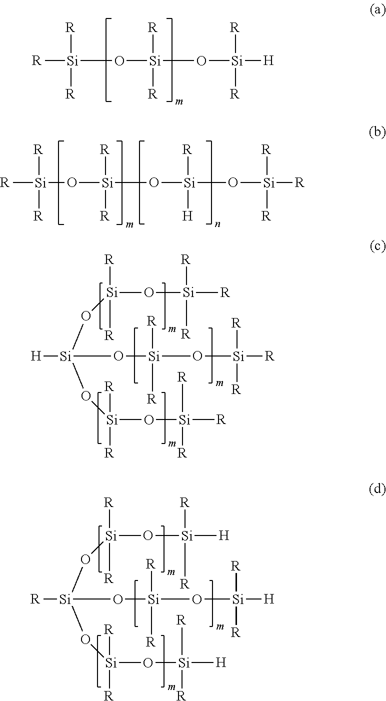

Suitable hydride terminated siloxane polymers of formula (II) may be hydride terminated polydimethylsiloxanes, hydride terminated methylhydrosiloxane-dimethylsiloxane copolymers, hydride terminated polyphenylmethylsiloxane, hydride terminated methylhydrosiloxane-phenylmethylsiloxane copolymer, hydride terminated polyphenyl-(dimethylhydrosiloxy)siloxane, hydride Q resin, monohydride terminated polydimethylsiloxanes or poly(methyl-hydridosilsesquioxane).

There is also provided another method for preparing a coating material, the method comprising the steps of:

providing a polymer having the following formula (III):

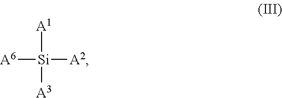

wherein A¹, A¹, and A³ may be independently R¹ or L², and at least one of A¹, A¹, and A³ is L²,

A⁶ may be selected from the group consisting of optionally substituted alkenyl, R¹, L³ and Z,

L³ may be

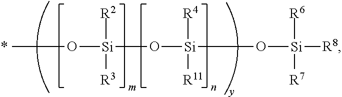

Z may be

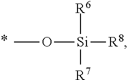

any two of R¹, R², R³, R⁴, R⁶, R⁷, R⁸ and R¹¹ may independently optionally be joined together to form a ring,

m may be 0 or an integer from 1 to 1000,

n may be 0 or an integer from 1 to 100,

y may be an integer from 1 to 1000,

R¹, R², R³, R⁴, R⁶, and R⁷ may be independently optionally substituted alkyl or optionally substituted aryl,

R⁸ and R¹¹ may be independently selected from the group consisting of optionally substituted alkenyl or R¹ and

at least one of A⁶, R⁸ or R¹¹ may be optionally substituted alkenyl, wherein when R¹¹ is optionally substituted alkenyl, n is not 0, and

contacting the polymer of formula (III) with M³ in the presence of a catalyst to form a covalent bond,

wherein M³ may be

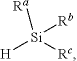

R^{a}, R^{b} and R^{c} may be independently halogen or —OR⁹, wherein R⁹ may be hydrogen or an alkyl.

In an embodiment, A¹ and A³ may be R¹, A² may be L³, and A⁶ may be Z, R¹, R², R³, R⁴, R⁶, R⁷ and R⁸ may be independently optionally substituted alkyl or optionally substituted aryl, and R¹¹ may be M³.

In another embodiment, A¹ and A³ may be R¹, A² may be L³, and A⁶ may be M², and R¹, R², R³, R⁴, R⁶, R⁷, R⁸ and R¹¹ may be independently optionally substituted alkyl or optionally substituted aryl.

In another embodiment, A¹ and A³ may be R¹, A² may be L³, A⁶ may be Z, R¹, R², R³, R⁴, R⁵, R⁶, and R⁷ may be independently optionally substituted alkyl or optionally substituted aryl and R¹¹ may be M³.

In another embodiment, A¹, A² and A³ may be independently L³, A⁶ may be Z, R², R³, R⁴, R⁶, R⁷ and R⁸ may be independently optionally substituted alkyl or optionally substituted aryl, and R¹¹ may be M³.

In another embodiment, A¹, A² and A³ may be independently L³, A⁶ may be M³, and R², R³, R⁴, R⁶, R⁷, R⁸ and R¹¹ may be independently optionally substituted alkyl.

In another embodiment, A¹, A² and A³ may be independently L³, A⁶ may be Z, R², R³, R⁴, R⁶, R⁷ and R¹¹ may be independently optionally substituted alkyl or optionally substituted aryl, and R⁸ may be M³.

The polymer of formula (III) may have the formula (e) or (h) below where the vinyl group is on a terminal position of a linear or branched polyorganosiloxane or may have the formula (f) or (g) below where the vinyl group is on the backbone of the polyorganosiloxane.

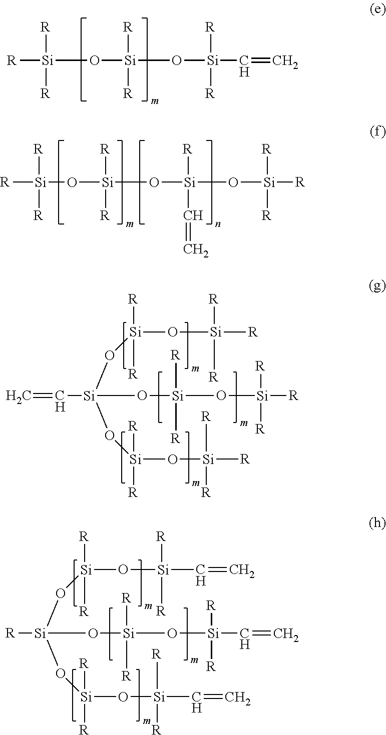

Suitable vinyl terminated siloxane polymers of formula (III) may be vinyl terminated polydimethylsiloxane, vinyl terminated polydiphenylsiloxane, vinyl terminated polyphenylmethylsiloxane, vinylmethylsiloxane copolymers, divinylsiloxanes or cyclic vinylsiloxanes, tetravinyltetramethylcyclotetrasiloxane, 1,3,5,7-tetravinyl-1,3,5,7-tetramethylcyclotetrasiloxane, vinylmethylsiloxane-dimethylsiloxane copolymers, vinyl terminated diphenylsiloxane-dimethylsiloxane copolymers, vinyl terminated trifluoropropylmethylsiloxane-dimethylsiloxane copolymer, vinylphenylmethyl terminated vinylphenylsiloxane-phenylmethylsiloxane copolymer, vinyl terminated diethylsiloxane-dimethylsiloxane copolymers, vinylmethylsiloxane-dimethylsiloxane copolymers, vinylmethylsiloxane-dimethylsiloxane copolymers, vinylmethylsiloxane homopolymers, monovinyl terminated polydimethylsiloxanes, monovinyl functional polydimethylsiloxane (symmetric), vinylmethylsiloxane terpolymers, vinylmethoxysiloxane homopolymer, vinylmethoxysiloxane homopolymer, vinylethoxysiloxane homopolymer.

The catalyst used in both methods stated above may be selected from group 10 elements. The group 10 element may be nickel, palladium or platinum.

The catalyst may comprise platinum. The catalyst may be platinum(0)-1,3-divinyl-1,1,3,3-tetramethyl-disiloxane, catalysts used in classical Pt-catalysis such as Speier's or Karstedt's catalysts, catalysts used in Rh-based catalysis such as [Rh(cod)₂]BF₄ or [RhCl(nbd)]₂, or catalysts used in Ru-based catalysts such as Wilkinson's catalyst, Grubbs' 1^{st} generation cacatalyst, [Ru(benzene)Cl₂]₂ or [Ru(p-cymene)Cl₂]₂), [Cp*Ru(MeCN)₃]PF₆.

There is also provided the use of the coating material as defined above for coating a substrate.

The coating material may be applied to a variety of hard or soft substrates. The substrate may be glass, ceramic, metal, paper, concrete, wood or plastics such as polyethylene terephthalate (PET), polypropylene (PP), poly(methyl methacrylate) (PMMA).

There is also provided a method of coating a substrate, the method comprising the steps of:
a) dissolving a coating material as defined above in a solvent to form a coating solution;
b) applying the coating solution on the substrate; and
c) removing the solvent.

The solvent may be an organic solvent. The organic solvent may be alcohols, ethers, esters or C₁ to C₄₀ hydrocarbons. The organic solvent may be toluene, ethyl acetate, isopropyl alcohol, ethanol or acetone.

The application step may be done by roll coating, brush coating, spray coating or dip coating.

The coating solution may have a concentration of less than 0.5 wt % of coating material or the polymer of formula (I). The coating solution may have a concentration of less than 0.4 wt % of coating material or the polymer of formula (I), less than 0.3 wt % of coating material or the polymer of formula (I), less than 0.2 wt % of coating material or the polymer of formula (I), less than 0.1 wt % of coating material or the polymer of formula (I), less than 0.07 wt % of coating material or the polymer of formula (I) or less than 0.05 wt % of coating material or the polymer of formula (I).

The coating material after the removing step (c) may be less than 700 nm in thickness. The coating material after the removing step (c) may be less than 600 nm, less than 500 nm, less than 400 nm, or less than 300 nm in thickness.

The step of removing the solvent may be performed at room temperature. The step of removing the solvent may be done by drying. The step of removing the solvent may be done by leaving the coated substrate to dry for a duration in the range of 5 to 30 minutes, 5 to 10 minutes, 5 to 20 minutes, 10 to 20 minutes or 20 to 30 minutes.

There is also provided a coated substrate obtainable by the method as defined above having hydrophobic properties.

The coated substrate may be for use in textile processing, packaging materials, paper industry, antifouling clothing, sportswear and boat sails.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1

FIG. 1 is a schematic representation of one method of preparation of silane terminated polyorganosiloxanes through hydrosilylation.

FIG. 2

FIG. 2 is a schematic representation of another method of preparation of silane terminated polyorganosiloxanes through hydrosilylation.

FIG. 3

FIG. 3 is a schematic representation of applying a hydrophobic coating of silane terminated polyorganosiloxanes on a substrate by hydrolysis and condensation at hydrated surfaces.

FIG. 4

FIG. 4 is a graph showing the water contact angle of glass slides immersed into different solutions of the inventive polymer (0.1 wt % in toluene) for 4 hours, measured after curing for 10 minutes at room temperature. The inserted images above each bar graph are optical images of static water droplets on the differently treated glass slides (5 μL per droplet).

FIG. 5

FIG. 5 is a graph showing the water contact angle of glass slides immersed into SP@ 1 solution (0.06 wt % in toluene) for different time periods, measured after curing at room temperature for 10 minutes. The inserted images above each bar graph are optical images of static water droplets on the differently treated glass slides (5 μL per droplet).

FIG. 6

FIG. 6 is a graph showing the water contact angle of glass slides immersed for 1 second into different solutions of the inventive polymer (0.05 wt % in toluene) in different organic solvents, measured after curing at room temperature for 10 minutes. The inserted images above each bar are optical images of static water droplets on the differently treated glass slides (5 μL per droplet).

FIG. 7

FIG. 7 is a graph showing the transmittance of glass coated with SP@ 1˜4 (w % 0.06% in toluene). The inserted images associated with each graph are optical images of static water droplets on the differently treated glass slides (5 μL per droplet).

FIG. 8

FIG. 8 refer to Scanning Electron Microscopy (SEM) images showing the surface morphology of glass coated with (B) SP@ 1, (C) SP@2, (D) SP@3 and (E) SP@4. The scale used in each figure is ×500.

FIG. 9

FIG. 9 refers to Atomic Force Microscopy (AFM) images of (A) un-coated and (C) SP@ 1 coated glass surfaces after scratching as well as graphs showing the results of the scratch tests on (B) uncoated and (D) SP@ 1 coated glass at the loads indicated. Cross profiles taken show the breadth and depth of scratch, with unperturbed surface set to 0 height and scratch depths appearing as negative values.

FIG. 10

FIG. 10 is a graph showing the water contact angle of glass slides coated with SP@ 1 treated under different conditions, such as heating at 300° for 1 day, under UV light irradiation for 3 days, and etching in acid, alkaline solution, and organic solvents for 3 days at room temperature.

The inserted images above each bar graph are optical images of static water droplets on the differently treated glass slides (5 μL per droplet).

FIG. 11

FIG. 11 refers to photographs of (A) uncoated glass, (B) SP@ 1 spray coated glass slide and (C) SP@ 1 spray coated glass slide after heating at 300° C. for 3 days followed by flushing with water and (D) a graph showing the transmittance of un-coated and spray coated glasses of SP@ 1 (0.06% in toluene).

FIG. 12

FIG. 12 is a graph showing the water contact angle of plastic and SP@ 1 coated plastic. The inserted images above each bar graph are optical images of static water droplets on the differently treated plastics (5 μL per droplet).

FIG. 13

FIG. 13 refer to photographs of static water droplets on swimming goggles (A) before and (B) after treatment with the inventive polymer.

FIG. 14

FIG. 14 refer to images showing the wetting behavior of water on a ceramic tile on the (A) smooth side and (C) porous and (B) smooth side spray coated with the inventive polymer, (D) porous side spray coated with the inventive polymer. (A1) to (D1): Optical images of static water droplets on the ceramic tile (5 μL per droplet). (A2) to (D2): photograph of blue-colored water droplets on ceramic tile (10 μL per droplet).

FIG. 15

FIG. 15 refer to images showing the wetting behavior of water on: cardboard un-coated (A1) and coated (A2) with SP; brick un-coated (B1) and coated (B3) with SP; brick coated with a commercial hydrophobic coating (B2), concrete un-coated (C1) and coated (C2) with SP; iron sheet un-coated (D1) and coated (D2) with SP; tissue un-coated (E1) and coated (E2) with SP; and wood un-coated (F1) and coated (F2) with SP.

### EXAMPLES

Non-limiting examples of the invention will be further described in greater detail by reference to specific Examples, which should not be construed as in any way limiting the scope of the invention.

### Example 1: Materials and Methods

Materials

Poly(dimethylsiloxane-co-methylhydrosiloxane), (trimethylsilyl terminated, Mn ˜13,000, methylhydrosiloxane 3-4 mol %), vinylsilanes, Speier's or Karstedt's catalysts were purchased from Sigma-Aldrich. Monodisperse hydride terminated polydimethylsiloxane (MW 600-800 and 4,500-5,000) were purchased from Gelest Inc. Other chemicals were purchased from Sigma-Aldrich and used as received.

Methods

Scanning electron microscopy (SEM) images were taken using a JEOL JSM 6700F operated at an acceleration voltage of 5.0 kV. Contact mode AFM was used to carry out EDPN experiments using a Dimension 3100 SPM (Bruker-Digital Instruments, Santa Barbara, Calif.) with a NanoScope IV controller and Nanoman software. Contact angle (CA) measurements were carried out on a ramd-hart Contact Angle Goniometers using liquid droplets of 5 μL in volume. UV-vis analyses were performed on a Shimadzu UV-3600 UV-Vis-NIR spectrophotometer (1-mm quartz cell used).

### Example 2: Synthesis of Polymer

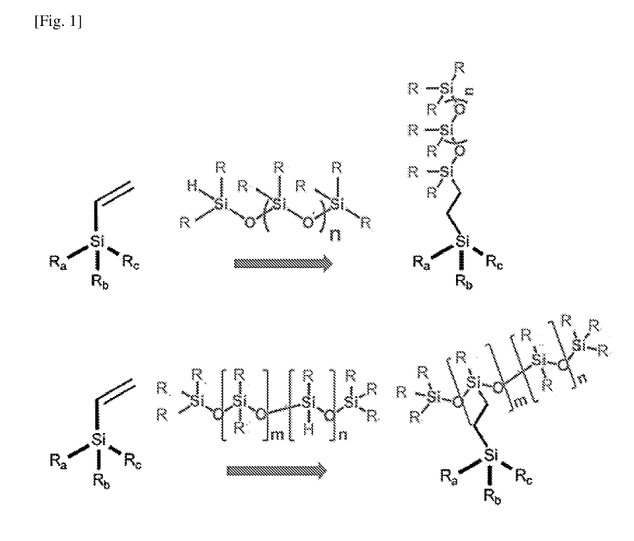

The straightforward one-step synthesis of silane-terminated polyorganosiloxanes (SP) through various cross-linking reactions is schematically depicted in FIG. 1 to FIG. 3. A typical synthetic method for preparing the coating material may involve a step of reacting vinylsilane directly with methylhydrosiloxane moieties of polyorganosiloxanes through hydrosilylation reaction as shown in FIG. 1.

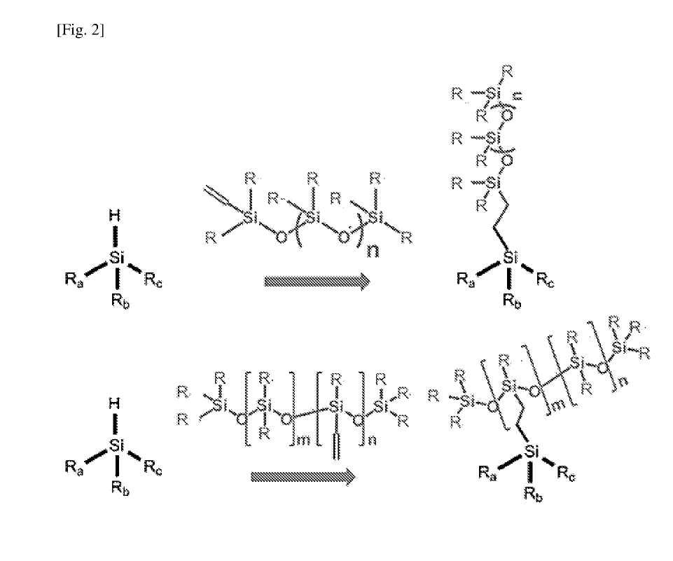

Alternatively, the vinyl group and methylhydrosiloxane moiety may be swapped to allow addition reaction between trimethoxysilane, triethoxysilane or trichlorosilane and vinyl-terminated linear or branched polyorganosiloxanes or vinylmethylsiloxane-dimethylsiloxane copolymers to form various silane terminated polyorganosiloxanes through hydrosilylation reaction as shown in FIG. 2.

In an example, hydride terminated polyorganosiloxane (2 g) and vinylsilane (0.16 g) were dissolved in 40 mL toluene at 80° C. Platinum(0)-1,3-divinyl-1,1,3,3-tetramethyl-disiloxane complex solution (50 μL) was dissolved in a minimum amount of toluene was added slowly under N₂. Once the addition was complete, the mixture was stirred overnight. Coupling various polyorganosiloxanes with vinylsilane gave SP in a near-quantitative yield. The following representative polymers were synthesized:

| | | Molecular |
|---|---|---|
| Name | Structure | weight |
| SP@1 | 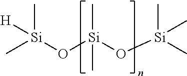 | 500 |
| SP@2 | 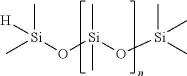 | 4500 |
| SP@3 | 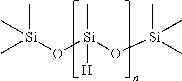 | 2700-3200 |
| SP@4 | 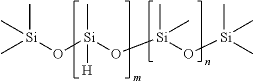 | 13000 |

### Example 3: Method of Coating

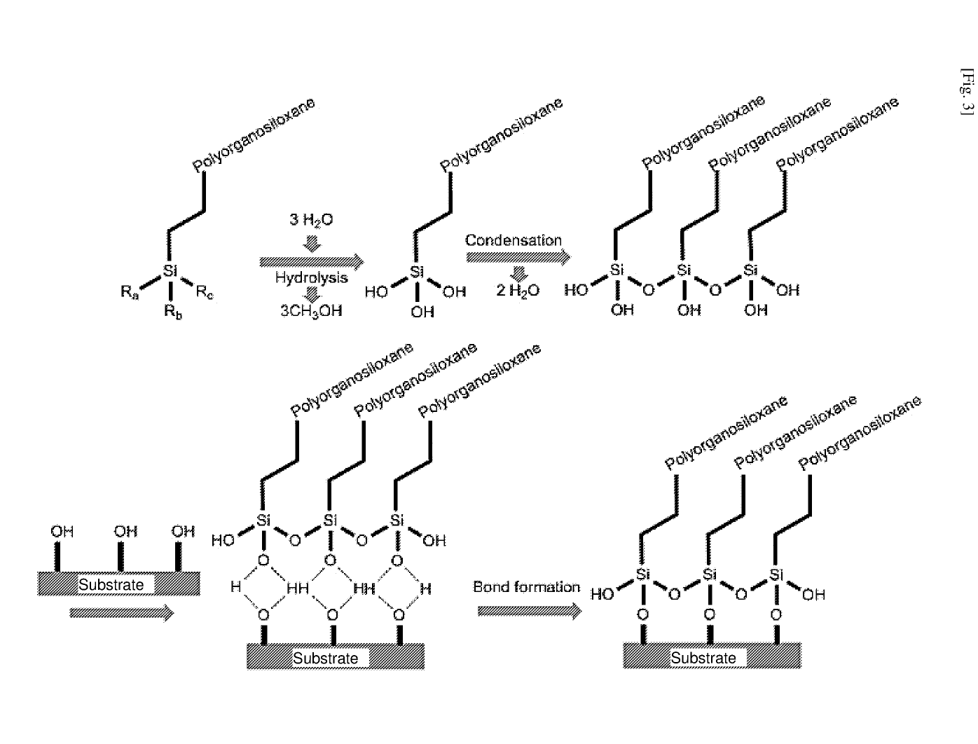

The overall process of immobilization of the coating material onto the surface via silanization is illustrated in FIG. 3. The silanol group usually is a hydrolyzable group, typically trimethylsilyl, triethoxysilyl and trichlorosilyl groups, which undergoes a hydrolysis and condensation reaction with hydrated surfaces of a substrate to result in covalent attachment of the polyorganosiloxane moieties onto the substrate surface.

The silane-terminated polyorganosiloxanes (SP) can be dissolved into various organic solvents (e.g. toluene, acetone, isopropyl alcohol, ethanol, ethyl acetate) to form coating solutions having a concentration of about 4 to 5 wt %. These coating solutions are directly applied onto the substrates using roll-coating, brush, spray and dipping coating so that SP can be uniformly coated onto the surface by a silanization process. After coating, the substrates were left at room temperature for 5 to 10 minutes to allow the solvent to evaporate and the polymer to cure.

### Example 4: Hydrophobicity

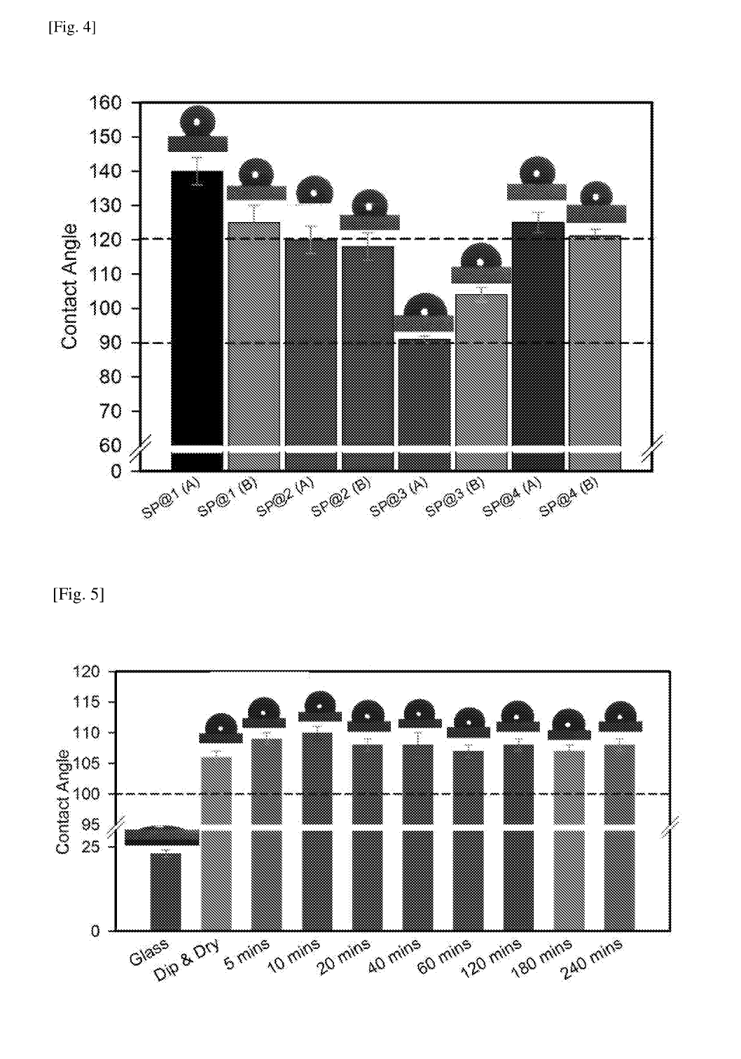

Once the inventive polymer is applied, a significant change in hydrophobicity of the substrate is observed as evidenced by the large increase in water contact angle (WCA). The WCAs of glass coated with SP@ 1 to SP@4 are indicated in FIG. 4. The uncoated glass had a WCA of approximately 30°. It can be seen that the glass slides immersed in SP coating solution for 4 hours at room temperature had an increased WCA of from about 90˜145°. Comparing the results show that the molecular weight and structure of polyorganosiloxanes play a key role in determining the hydrophobicity of coated glass surface.

In a separate experiment, glass slides were immersed into SP@ 1 coating solution for various time periods at room temperature. By simply dipping for 1 second and then drying, the glass slide was able to achieve surface hydrophobicity with a WCA of 105°. As shown in FIG. 5, immersion in the coating solution for 10 minutes was sufficient to obtain a contact angle of around 110°. It indicated silane-terminated polyorganosiloxanes (SP) can be quickly cured to form a hydrophobic layer on the substrates.

The preferred solvents used for hydrophobic coating include alcohols, ethers, esters or C₁ to C₄₀ hydrocarbons. FIG. 6 shows the water contact angles of glass slides coated with SP in toluene, ethyl acetate, isopropyl alcohol, ethanol and acetone. The results indicated the solvents do not significantly affect the coating results or the WCA achievable by the coating.

### Example 5: Optical Properties

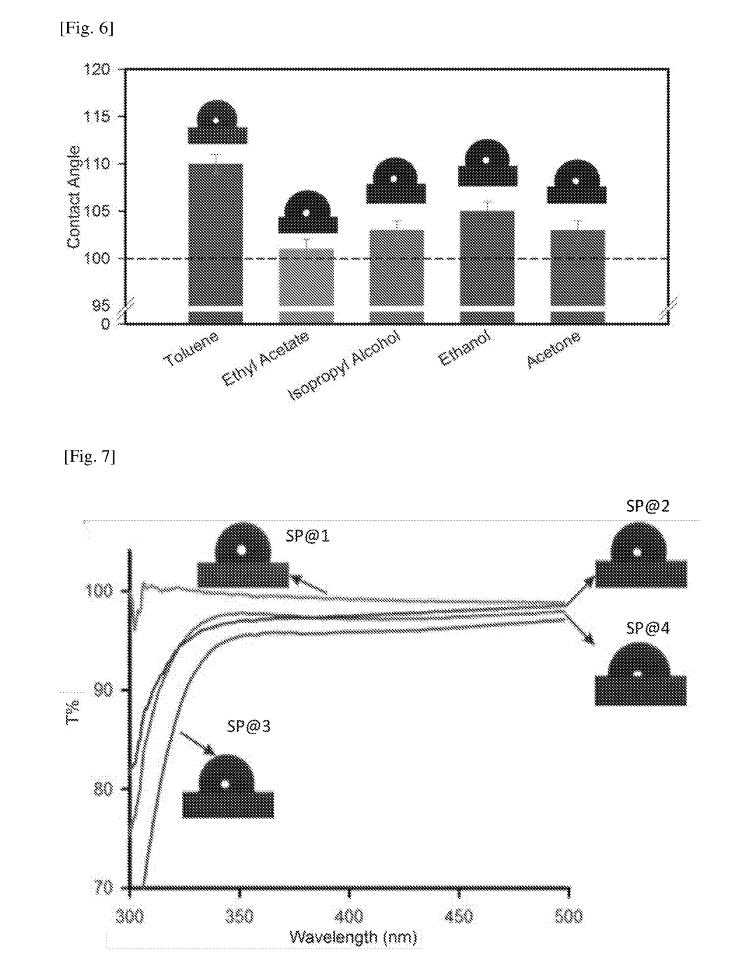

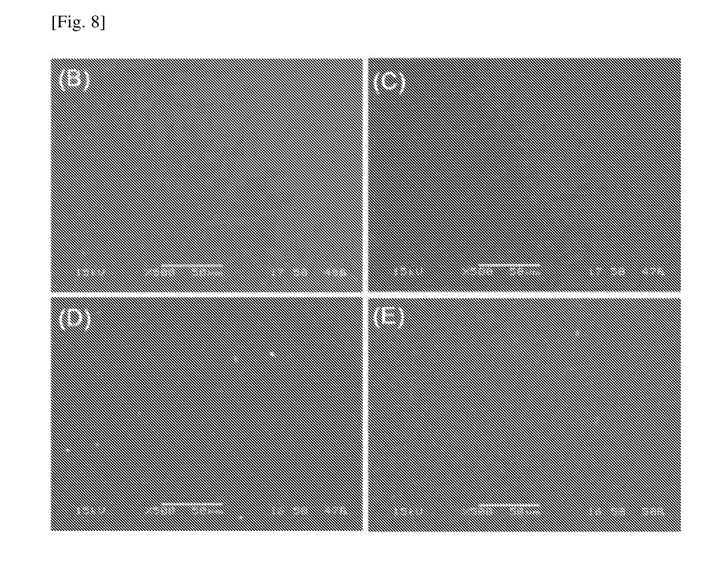

FIG. 7 shows the optical transparency and FIG. 8 shows the surface morphology glass substrates coated with SP@ 1 to SP@4. It can be seen that the modification of glass slides with silane-terminated polyorganosiloxanes (SP) improves their surface hydrophobicity without changing surface morphology or decreasing the transparency of the substrate.

### Example 6: Durability

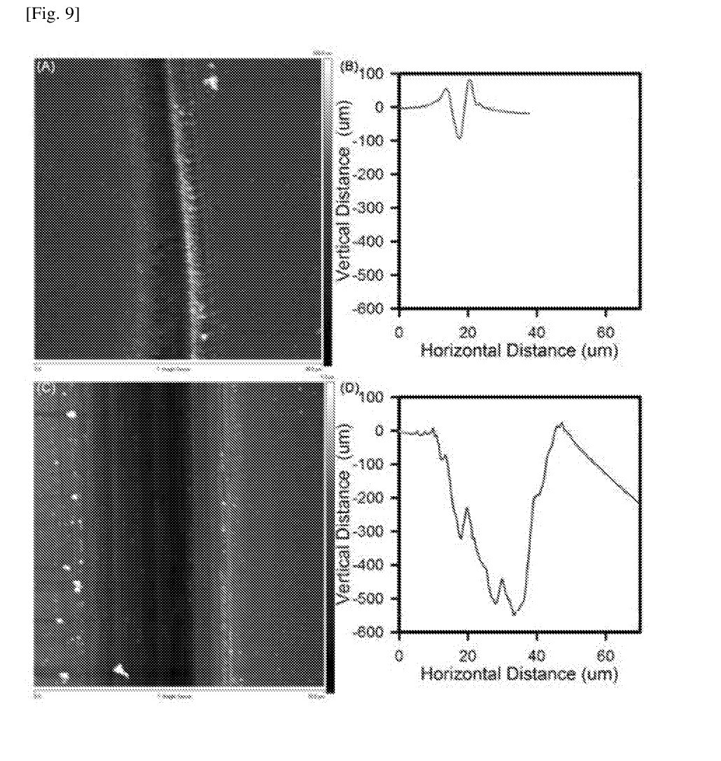

FIG. 9 shows the Atomic Force Microscopy (AFM) images of the glass substrates with and without coatings with SP@ 1 after being scratched. Scratch profiles on the glass coated with SP@ 1 (B) are qualitatively different than for the uncoated glass (A). The depth of the scratch on uncoated and coated glass is 83 and 593 nm, respectively. This result indicates that the thickness of the SP film that is formed on the substrate is about 400 nm.

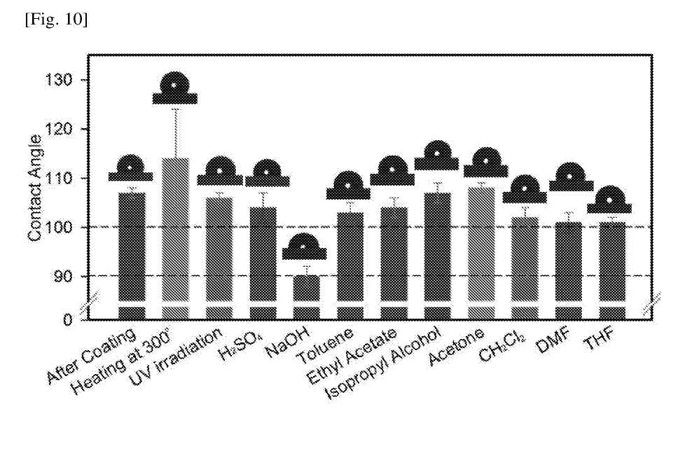

The long-term stability of the hydrophobic coating in various conditions is exceptionally important for many aspects of practical applications. The durability of the SP coated on glass was evaluated by WCA analysis of the glass substrate after exposure to organic solvents, acid/alkali etching, heating and UV light irradiation (FIG. 10). FIG. 10 shows that the SP coating layer exhibits excellent resistance to strong acid and organic solvents, and resistance to a certain extent to strong corrosive alkaline solutions. Furthermore, it was shown that the SP coating had good thermal stability at high temperature. The experimental results show that the coated glass in fact displayed a higher water contact angle after heating at 300° for 24 hours. In addition, hydrophobic stability under UV light irradiation was examined. As showed in FIG. 10, the contact angles of glass coated with SP@ 1 still remained more than 105° after irradiation at 40° C. for 3 days. Overall, excellent stability of the SP coating was observed, demonstrating that it may have a wide variety of potential applications even under harsh conditions.

### Example 7: Coating of Objects

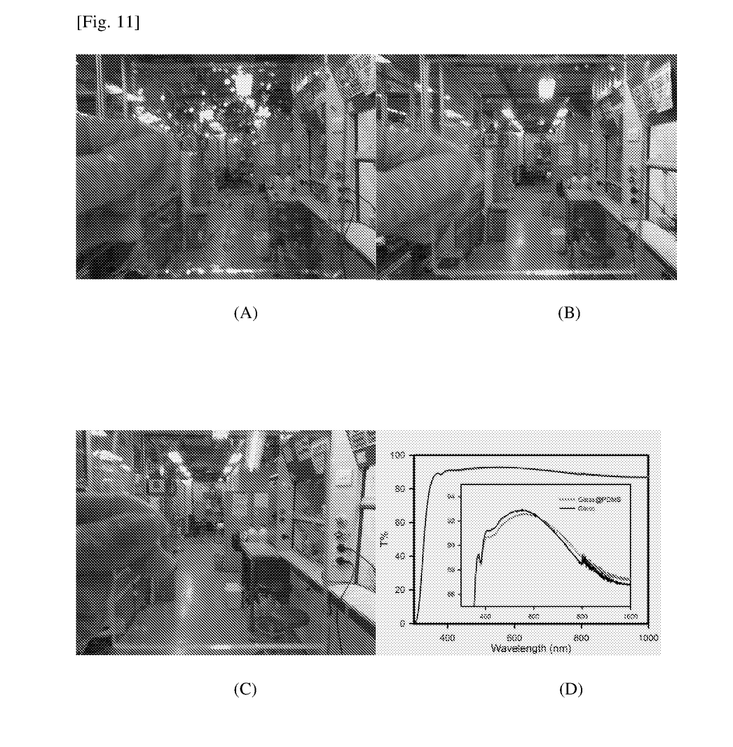

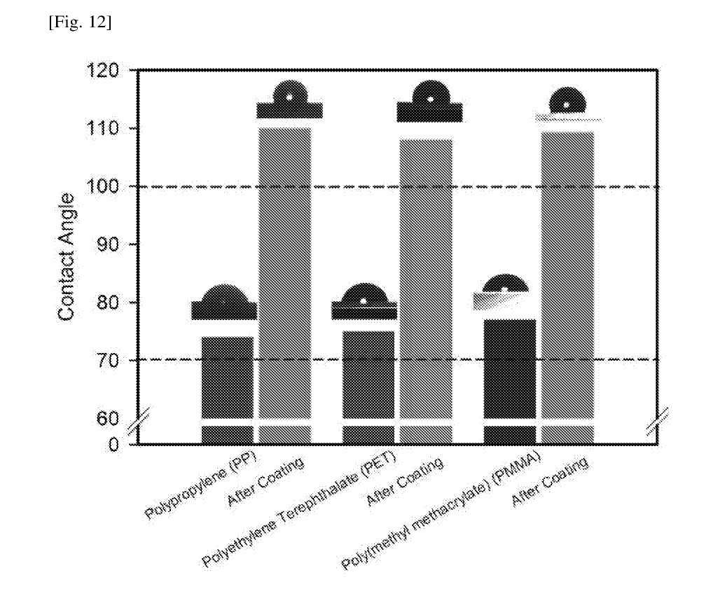

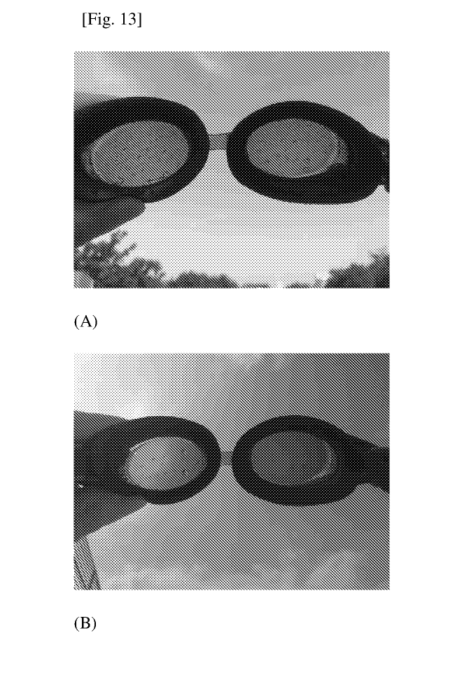

The coating material can be applied onto objects to render them water-repellent. FIG. 11 shows a glass slide washed with water after being spray coated with SP@ 1. The photo in FIG. 11(A) to (C) indicates that a thermally stable transparent hydrophobic layer was formed on the glass surface after being sprayed with the SP coating solution and the solvent was evaporated. It is to be noted that there was no change on hydrophobicity even after heating the glass slide at 300° C. for 3 days. FIG. 11(D) indicates that the transparency of the glass substrate is not affected by the SP@ 1 coating. It is well known that organic materials are difficult to graft onto plastic materials. This is because plastics are usually hydrophobic polymers in nature. To this end, SP coating on various synthetic plastic materials, such as polyethylene terephthalate (PET), polypropylene (PP), and poly(methyl methacrylate) (PMMA) were tested. FIG. 12 shows the static water contact angle (WCA) on SP modified plastic surfaces. The WCA measurement revealed that plastics coated with SP showed a WCA of approximately 110°. In contrast, untreated plastics only showed a water contact angle of about 75°. This shows that the SP coating material can be applied to plastic substrates. This was further tested by spray coating the plastic in swimming goggle lenses with SP, as shown in FIG. 13. FIG. 13 shows that goggle lenses coated with SP can facilitate clearer vision after wetting by water.

Further, as shown in Table 1, polyethylene and polypropylene were spray coated with SP and further surface modified with corona treatment. It was found that the WCA of the SP coated materials were the highest among non-fluorinated materials.

TABLE 1
WCA of plastics coated with SP with and without corona treatment.

| | | Contact angle of pure water |
|---|---|---|
| Sample | Coated on | (degrees) |
| Polyethylene | with corona | 93.8 |
| | without corona | 97.5 |
| Polyethylene with SP | with corona | 107.9 |
| coating | without corona | 110.5 |
| Polypropylene | with corona | 81.4 |
| | without corona | 102 |
| Polypropylene with | with corona | 108.8 |
| SP coating | without corona | 110.5 |

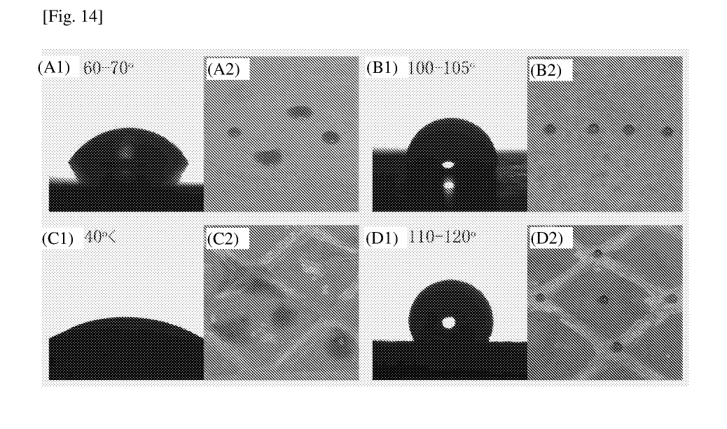

Surface silanization was also performed to introduce hydrophobicity on surfaces of ceramic materials. Success in the fabrication of SP coating on the surface of a ceramic tile (having a smooth side and a porous side) was ascertained by water contact angle measurements. The uncoated ceramic tile had a hydrophilic surface as shown in FIGS. 14(A) and (C), where the water contact angle was found to be around 60° to 70° on the smooth side and below 40° on the porous side of the ceramic tile. On the porous side of the ceramic tile, water droplets were ultimately absorbed in to the ceramic material.

In contrast, as shown in FIGS. 14(B) and (D), the SP coated ceramic tile showed hydrophobic properties on both the smooth and porous sides of ceramic tile. The WCA on the smooth side of ceramic tile was substantially increased to 105° to 110° after coating with SP. The porous side of the ceramic tile showed an even more significant increase in WCA, from less than 40° uncoated, to 110° to 120° after coating with SP. Without being bound to theory, it is thought that the SP coating material takes advantage of the inherent morphological anisotropy of the porous side of the ceramic tile, which provides a roughness in the micro scale to further enhance the surface hydrophobicity. The wettability of various materials therefore appears to be dependent on both the physical and chemical heterogeneity of the material.

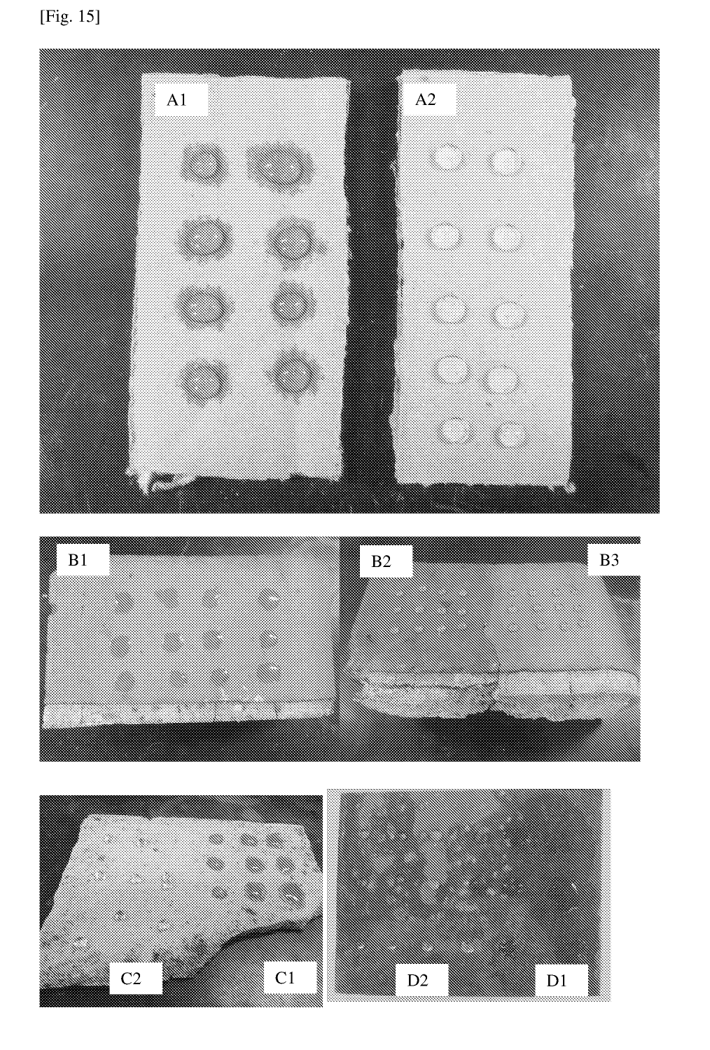

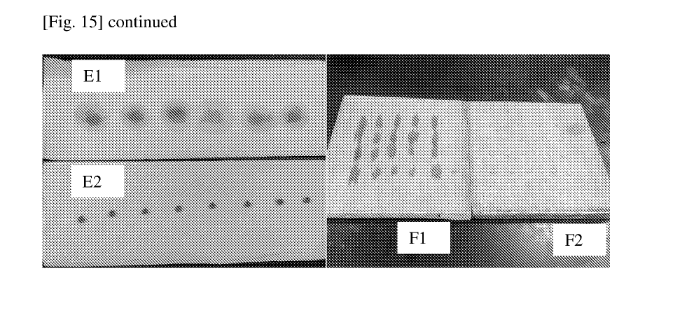

Furthermore, this coating material can also be applied to other substrates, such as cardboards and bricks. As showed in FIG. 15, the naturally hydrophilic surface of cardboard, brick, concrete, iron sheet, tissue and wood were changed to become hydrophobic by simple spray coating with the SP coating material. Cardboard coated with SP becomes hydrophobic (FIG. 15A2) compared to uncoated cardboard (FIG. 15A1). FIG. 15B1 shows uncoated brick and FIG. 15B3 shows brick coated with SP and a commercial hydrophobic coating (FIG. 15B2). It can be seen that SP coating has comparable hydrophobicity as the commercial product. FIG. 15C1 is uncoated concrete and FIG. 15C2 shows concrete coated with SP. FIG. 15D1 is uncoated iron sheet and FIG. 15D2 shows iron sheet coated with SP. Similarly, FIG. 15E2 and FIG. 15F2 is uncoated paper and wood, respectively, and FIG. 15E1 and FIG. 15F1 are paper and wood, respectively, coated with SP. It was noted that if the substrate has a rough surface, a water contact angle of approximately 150° could be achieved, suggesting higher hydrophobicity. The coating materials did not change the colour of the substrates. More importantly, the hydrophobic properties of the coated objects were comparable with that of commercial products.

In summary, silanes terminated polyorganosiloxanes exhibit pronounced hydrophobic features that facilitates its application to various substrates such as glass, plastics, metal and ceramics, using a simple coating process to achieve transparent hydrophobic coatings. Typically, such coating materials present thermal and acid/base stability and hold a potential for a variety of applications in the areas of anti-biofouling paints for boats, anti-sticking of snow for antennas and windows, self-cleaning windshields for automobiles, metal refining, stain resistant textiles, and anti-soiling architectural coatings.

### INDUSTRIAL APPLICABILITY

The disclosed coating material and substrates coated with the coating material may be useful as a transparent self-cleaning or anti-biofouling coating in paints for boats, anti-sticking coating of snow for antennas and windows, self-cleaning windshields for automobiles, metal refining, stain resistant textiles, textile processing, anti-soiling architectural coatings, packaging materials, building materials, the paper industry, construction industry, optical instrument, glass balconies, doors, windows, showers, boat sails, cruise bus/ships, kitchens, skyscrapers, aircraft, as well as electronic components where clear visibility through the substrate is required.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A coating material comprising a polymer having the following formula (I): 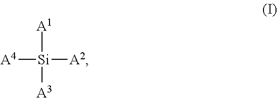
wherein A¹, A² and A³ are independently R¹ or L¹, and at least one of A¹, A², or A³ is L¹,
A⁴ is selected from the group consisting of hydrogen, optionally substituted alkenyl, R¹, L¹, M¹, and Z,
L¹ is 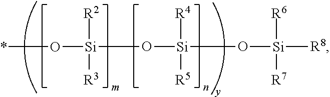
M¹ is 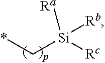
Z is 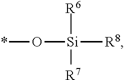
any two of R¹, R², R³, R⁴, R⁵, R⁶, R⁷ and R⁸ may independently optionally be joined together to form a ring,
m is 0 or an integer from 1 to 1000,
n is 0 or an integer from 1 to 100,
y is an integer from 1 to 1000, R¹, R², R³, R⁴, R⁶, and R⁷ are independently optionally substituted alkyl or optionally substituted aryl,
R⁵ and R⁸ are independently selected from the group consisting of hydrogen, R¹, optionally substituted alkenyl, and M¹,
at least one of A⁴, R⁵ or R⁸ is M¹, wherein when R⁵ is M¹, n is not 0,
R^{a}, R^{b} and R^{c} are independently halogen or —OR⁹, wherein R⁹ is hydrogen or an alkyl, and
p is an integer from 1 to 10.

2. The coating material of claim 1, wherein R¹, R², R³, R⁴, R⁶, and R⁷ are independently optionally substituted C₁ to C₅₀ alkyl.

3. The coating material of claim 1, wherein R¹, R², R³, R⁴, R⁶, and R⁷ are independently selected from the group consisting of methyl, ethyl, n-propyl, isopropyl, n-butyl, sec-butyl, isobutyl, tert-butyl, n-pentyl, tert-pentyl, neo-pentyl, isopentyl, sec-pentyl, 3-pentyl, hexyl, heptyl, octyl and phenyl.

4. (canceled)

5. The coating material according to of claim 1, wherein the optionally substituted alkenyl is an optionally substituted C₂ to C₁₀ alkenyl.

6. (canceled)

7. The coating material of claim 1, wherein A¹ and A³ are R¹, A² is L¹, and A⁴ is Z, R¹, R², R³, R⁴, R⁶, R⁷ and R⁸ are independently optionally substituted alkyl or optionally substituted aryl, and R⁵ is M¹.

8. The coating material of claim 1, wherein A¹ and A³ are R¹, A² is L¹, and A⁴ is M¹, and R¹, R², R³, R⁴, R⁵, R⁶, R⁷ and R⁸ are independently optionally substituted alkyl or optionally substituted aryl.

9. The coating material of claim 1, wherein A¹ and A³ are R¹, A² is L¹, A⁴ is Z, R¹, R², R³, R⁴, R⁵, R⁶, and R⁷ are independently optionally substituted alkyl or optionally substituted aryl and R⁸ is M¹.

10. The coating material of claim 1, wherein A¹, A² and A³ are independently L¹, A⁴ is Z, R², R³, R⁴, R⁶, R⁷ and R⁸ are independently optionally substituted alkyl or optionally substituted aryl, and R⁵ is M¹.

11. The coating material of claim 1, wherein A¹, A² and A³ are independently L¹, A⁴ is M¹, and R², R³, R⁴, R⁵, R⁶, R⁷ and R⁸ are independently optionally substituted alkyl.

12. The coating material of claim 1, wherein A¹, A² and A³ are independently L¹, A⁴ is Z, R², R³, R⁴, R⁵, R⁶ and R⁷ are independently optionally substituted alkyl or optionally substituted aryl, and R⁸ is M¹.

13. The coating material of claim 1, wherein R^{a}, R^{b} and R^{c} are independently selected from the group consisting of chloride, —OH, —OCH₃ and —OCH₂CH₃.

14. The coating material of claim 1, wherein M is selected from the group consisting of trimethoxysilane, triethoxysilane and trichlorosilane.

15. The coating material of claim 1, further comprising a solvent.

16. A method for preparing a coating material, the method comprising:
providing a polymer having the following formula (II): 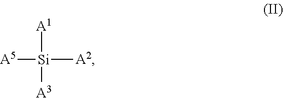
wherein A¹, A², and A³ are independently R¹ or L², and at least one of A¹, A², and A³ is L²,
A⁵ is selected from the group consisting of hydrogen, R¹, L² and Z,
L² is, 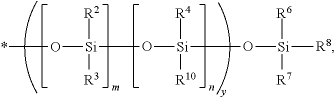
Z is 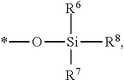
any two of R¹, R², R³, R⁴, R⁶, R⁷, R⁸ and R¹⁰ may independently optionally be joined together to form a ring,
m is 0 or an integer from 1 to 1000,
n is 0 or an integer from 1 to 100,
y is an integer from 1 to 1000,
R¹, R², R³, R⁴, R⁶, and R⁷ are independently optionally substituted alkyl or optionally substituted aryl,
R⁸ and R¹⁰ are independently hydrogen or R¹ and
at least one of A⁵, R⁸ or R¹⁰ is hydrogen, wherein when R¹⁰ is hydrogen, n is not 0, and contacting the polymer of formula (II) with M² in the presence of a catalyst to form a covalent bond,
wherein M² is 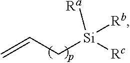
R^{a}, R^{b} and R^{c} are independently halogen or —OR⁹, wherein R⁹ is hydrogen or an alkyl, and
p is an integer from 1 to 10.

17. A method for preparing a coating material, the method comprising:
providing a polymer having the following formula (I): 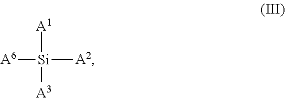
wherein A^{L}, A², and A³ are independently R¹ or L², and at least one of A¹, A², and A³ is L²,
A⁶ is selected from the group consisting of optionally substituted alkenyl, R¹, L³ and Z,
L³ is 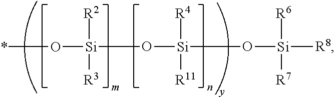
Z is 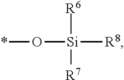
any two of R¹, R², R³, R⁴, R⁶, R⁷, R⁸ and R¹¹ may independently optionally be joined together to form a ring,
m is 0 or an integer from 1 to 1000,
n is 0 or an integer from 1 to 100,
y is an integer from 1 to 1000,
R¹, R², R³, R⁴, R⁶, and R⁷ are independently optionally substituted alkyl or optionally substituted aryl,
R⁸ and R¹¹ are independently optionally substituted alkenyl or R¹ and
at least one of A⁶, R⁸ or R¹¹ is optionally substituted alkenyl, wherein when R¹¹ is optionally substituted alkenyl, n is not 0, and
contacting the polymer of formula (III) with M³ in the presence of a catalyst to form a covalent bond,
wherein M³ is 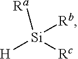
R^{a}, R^{b} and R^{c} are independently halogen or —OR⁹, wherein R⁹ is hydrogen or an alkyl.

18. The method of claim 16, wherein the catalyst is selected from group 10 elements.

19-20. (canceled)

21. A method of coating a substrate, the method comprising:
a) dissolving a coating material comprising a polymer having the following formula (I): 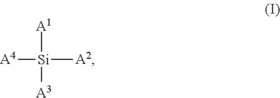
wherein A¹, A² and A³ are independently R¹ or L¹, and at least one of A¹, A², or A³ is L¹,
A⁴ is selected from the group consisting of hydrogen, optionally substituted alkenyl, R¹, L¹, M¹, and Z,
L¹ is 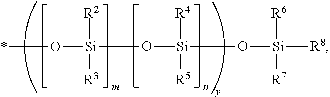
M¹ is 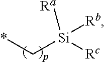
Z is 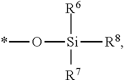
any two of R¹, R², R³, R⁴, R⁵, R⁶, R⁷ and R⁸ may independently optionally be joined together to form a ring,
m is 0 or an integer from 1 to 1000,
n is 0 or an integer from 1 to 100,
y is an integer from 1 to 1000, R¹, R², R³, R⁴, R⁶, and R⁷ are independently optionally substituted alkyl or optionally substituted aryl,
R⁵ and R⁸ are independently selected from the group consisting of hydrogen, R¹, optionally substituted alkenyl, and M¹,
at least one of A⁴, R⁵ or R⁸ is M¹, wherein when R⁵ is M¹, n is not 0,
R^{a}, R^{b} and R^{c} are independently halogen or —OR⁹, wherein R⁹ is hydrogen or an alkyl, and
p is an integer from 1 to 10 in a solvent to form a coating solution;
b) applying the coating solution on the substrate; and
c) removing the solvent.

22. The method of claim 21, wherein the solvent is an organic solvent or wherein the substrate is selected from the group consisting of plastic, ceramic, wood, paper and metal.

23. The method according to claim 21, wherein the application step is done by roll coating, brush coating, spray coating or dip coating.

24. (canceled)

25. The method according to claim 21, wherein the coating solution has a concentration of less than 0.5 wt % of coating material or wherein the coating material after the removing step (c) is less than 700 nm in thickness.

26-27. (canceled)
